(19) United States
(12) Patent Application Publication
(10) Pub. No.: US 2012/0075283 A1
(43) Pub. Date: Mar. 29, 2012

(54) PLASMA DISPLAY PANEL DRIVE METHOD AND PLASMA DISPLAY DEVICE

(75) Inventors: Yutaka Yoshihama, Osaka (JP); Kenji Ogawa, Osaka (JP); Takateru Sawada, Osaka (JP); Toshiyuki Maeda, Hyogo (JP); Keiji Akamatsu, Hyogo (JP)

(73) Assignee: Panasonic Corporation, Osaka (JP)

(21) Appl. No.: 13/376,527

(22) PCT Filed: Jun. 7, 2010
(86) PCT No.: PCT/JP10/03779

§ 371 Date: Dec. 6, 2011

(30) Foreign Application Priority Data
Jun. 8, 2009 (JP) 2009-136970
Jun. 10, 2009 (JP) 2009-138882

(51) Int. Cl. G09G 5/00; G09G 3/28

(52) U.S. Cl. 345/212; 345/60

(57) ABSTRACT

In a driving method for a plasma display panel, in the initializing period in at least one of a plurality of subfields, selective initializing operation is performed that selectively causes initializing discharge only in a discharge cell having undergone address discharge in an immediately preceding address period. The selective initializing operation includes the step of applying first voltage to the sustain electrode and applying an up-ramp waveform voltage to the scan electrode, the step of applying a first down-ramp waveform voltage to the scan electrode and then applying a positive rectangular voltage to it, and the step of applying second voltage higher than the first voltage to the sustain electrode and applying a second down-ramp waveform voltage to the scan electrode.

This application is a U.S. National Phase Application of PCT International Application PCT/JP2010/003779.

### TECHNICAL FIELD

The present invention relates to a driving method for a plasma display panel of an alternating-current surface discharge type, and a plasma display apparatus.

### BACKGROUND ART

A plasma display panel (hereinafter referred to as “panel”) has a plurality of discharge cells having a scan electrode, a sustain electrode, and a data electrode. The plasma display panel excites respective phosphors of red, green, and blue to emit light with ultraviolet rays generated by gas discharge in the discharge cells, and thus provides color display.

A subfield method is generally used as a method of driving the panel. In this method, one field is formed using a plurality of subfields including an initializing period, an address period, and a sustain period, and the subfields in which light is emitted are combined, thereby performing gradation display. In each subfield, initializing operation is performed in the initializing period, address operation is performed in the address period, and sustain operation is performed in the sustain period. The initializing operation is operation of causing initializing discharge and producing wall charge required for the subsequent address operation. The initializing operation includes a forced initializing operation of causing initializing discharge regardless of the operation in the immediately preceding subfield, and a selective initializing operation of causing initializing discharge only in the discharge cell that has undergone address discharge in the immediately preceding subfield. The address operation is operation of selectively causing address discharge in a discharge cell according to an image to be displayed and producing wall charge. The sustain operation is operation of alternately applying a sustain pulse to a display electrode pair t o cause sustain discharge, and emitting light in a phosphor layer in the corresponding discharge cell. The light emission in the phosphor layer by this sustain discharge is related to gradation display, and the other light emission is not related to the gradation display.

A driving method has been studied in which the luminance in displaying black of the lowest gradation in the subfield method is reduced, the light emission that is not related to the gradation display is reduced as much as possible, and the contrast is improved. For example, Patent Literature 1 discloses a driving method in which the number of subfields for performing the forced initializing operation is set to one per field and the selective initializing operation is performed in the other subfields.

Patent Literature 2 discloses a driving method in which an up-ramp waveform voltage is applied to the scan electrode at the end of the sustain period, a down-ramp waveform voltage is applied to the scan electrode in the subsequent initializing period, thereby performing the selective initializing operation.

Patent Literature 3 discloses a driving method having an abnormal charge erasing period in which a rectangular waveform voltage is applied to the scan electrode after the initializing period of a subfield for performing the forced initializing operation.

As described in Patent Literature 2, waveform distortion such as ringing is suppressed by using ramp waveform voltage as the driving voltage, and hence the driving voltage is accurately applied to each electrode of each discharge cell. Therefore, when the ramp waveform voltage is used as the driving voltage in the initializing period, stable address discharge can be caused in the subsequent address period. However, the discharge using the ramp waveform voltage is feeble, and the voltage range capable of being applied to each electrode for the selective initializing operation is restricted. Therefore, it is difficult to cause discharge large enough to completely erase the history of the wall charge of the discharge cell before then. Therefore, the driving condition changes between the discharge cell that has undergone address discharge in the immediately preceding subfield and the discharge cell that has undergone no address discharge, and hence the voltage setting margin of the driving voltage becomes narrow, disadvantageously.

### Citation List

[Patent Literature]

[PTL 1] Unexamined Japanese Patent Publication No. 2000-242224

[PTL 2] Unexamined Japanese Patent Publication No. 2008-256774

[PTL 3] International Patent Publication No. WO2008/059745

### SUMMARY OF THE INVENTION

The present invention provides a driving method for a panel and a plasma display apparatus where a stable address discharge is caused with sufficient voltage setting margin secured and an image of high display quality can be displayed.

In a driving method for a panel of the present invention, one field is formed using a plurality of subfields that has an initializing period, an address period, and a sustain period, and a panel is driven that has a plurality of discharge cells having a scan electrode, a sustain electrode, and a data electrode. In the initializing period in at least one of the plurality of subfields, the selective initializing operation is performed that selectively causes the initializing discharge only in the discharge cell having undergone address discharge in the immediately preceding address period. The selective initializing operation includes the following steps:
applying first voltage to the sustain electrode and applying an up-ramp waveform voltage to the scan electrode;
applying a first down-ramp waveform voltage to the scan electrode and then applying a positive rectangular voltage to it; and
applying second voltage higher than the first voltage to the sustain electrode and applying a second down-ramp waveform voltage to the scan electrode. This method can provide a driving method for a panel that can cause stable address discharge while securing the sufficient voltage setting margin and can display an image of high display quality.

A plasma display apparatus of the present invention has the following elements:
a panel that has a plurality of discharge cells including a scan electrode, a sustain electrode, and a data electrode; and
a driver circuit that forms one field using a plurality of subfields having an initializing period, an address period, and a sustain period, generates a driving voltage, and applies the driving voltage to each electrode of the panel. In the initializing period in at least one of the plurality of subfields, the driver circuit applies first voltage to the sustain electrode and applies an up-ramp waveform voltage to the scan electrode, then applies a first down-ramp waveform voltage to the scan electrode, then applies a positive rectangular voltage to the scan electrode, then applies second voltage higher than the first voltage to the sustain electrode and applies a second down-ramp waveform voltage to the scan electrode, thereby driving the panel. This configuration can provide a plasma display apparatus that can cause stable address discharge while securing the sufficient voltage setting margin and can display an image of high display quality.

In a driving method for a panel of the present invention, one field is formed of a plurality of subfields having an address period, a sustain period, and an erasing period and a panel is driven that has a plurality of discharge cells having a scan electrode, a sustain electrode, and a data electrode. First voltage is assumed to be the voltage derived by subtracting the voltage applied to the data electrode from the low-side voltage of the sustain pulse applied to the scan electrode in the sustain period. Second voltage is assumed to be the voltage derived by subtracting the voltage applied to the data electrode from the high-side voltage of the sustain pulse applied to the scan electrode in the sustain period. Third voltage is assumed to be the voltage derived by subtracting the low-side voltage of the address pulse applied to the data electrode from the low-side voltage of the scan pulse applied to the scan electrode in the address period. The voltage derived by subtracting the third voltage from the first voltage is not lower than a discharge start voltage where the data electrode is used as the positive electrode and the scan electrode is used as the negative electrode. The voltage derived by subtracting the third voltage from the second voltage is lower than the sum of the discharge start voltage where the data electrode is used as the positive electrode and the scan electrode is used as the negative electrode and the discharge start voltage where the data electrode is used as the negative electrode and the scan electrode is used as the positive electrode. In the erasing period, erasing discharge is selectively caused only in the discharge cell that has undergone address discharge in the immediately preceding address period. The erasing discharge includes the following steps:
causing first discharge where the sustain electrode is used as the negative electrode and the scan electrode is used as the positive electrode;
causing first discharge where the scan electrode is used as the negative electrode and the data electrode is used as the positive electrode;
causing second discharge where the sustain electrode is used as the negative electrode and the scan electrode is used as the positive electrode; and
causing second discharge where the scan electrode is used as the negative electrode and the data electrode is used as the positive electrode.
   This method can provide a driving method for a panel where the forced initializing operation is omitted while the address operation is caused stably, the light emission that is not related to the gradation display is eliminated, and the contrast is largely improved.

In a driving method for a panel of the present invention, the following first discharge and second discharge may be caused in the erasing discharge. In other words, the first discharge where the sustain electrode is used as the negative electrode and the scan electrode is used as the positive electrode is caused by applying fourth voltage to the sustain electrode and applying an up-ramp waveform voltage to the scan electrode. The second discharge where the sustain electrode is used as the negative electrode and the scan electrode is used as the positive electrode is caused by applying fifth voltage higher than the fourth voltage to the sustain electrode and applying a down-ramp waveform voltage to the scan electrode.

A plasma display apparatus of the present invention has the following elements:
a panel that has a plurality of discharge cells including a scan electrode, a sustain electrode, and a data electrode; and
a driver circuit that forms one field using a plurality of subfields having an address period, a sustain period, and an erasing period, generates a driving voltage waveform, and applies the driving voltage waveform to each electrode of the panel. The driver circuit drives the panel in the following manner. First voltage is assumed to be the voltage derived by subtracting the voltage applied to the data electrode from the low-side voltage of the sustain pulse applied to the scan electrode in the sustain period. Second voltage is assumed to be the voltage derived by subtracting the voltage applied to the data electrode from the high-side voltage of the sustain pulse applied to the scan electrode in the sustain period. Third voltage is assumed to be the voltage derived by subtracting the low-side voltage of the address pulse applied to the data electrode from the low-side voltage of the scan pulse applied to the scan electrode in the address period. The voltage derived by subtracting the third voltage from the first voltage is set to be not lower than a discharge start voltage where the data electrode is used as the positive electrode and the scan electrode is used as the negative electrode. The voltage derived by subtracting the third voltage from the second voltage is set not to exceed the sum of the discharge start voltage where the data electrode is used as the positive electrode and the scan electrode is used as the negative electrode and the discharge start voltage where the data electrode is used as the negative electrode and the scan electrode is used as the positive electrode. In the erasing period, the following processes are performed:
causing first discharge where the sustain electrode is used as the negative electrode and the scan electrode used as the positive electrode;
then, causing first discharge where the scan electrode is used as the negative electrode and the data electrode is used as the positive electrode;
then, causing second discharge where the sustain electrode is used as the negative electrode and the scan electrode is used as the positive electrode;
then, causing second discharge where the scan electrode is used as the negative electrode and the data electrode is used as the positive electrode; and
selectively causing erasing discharge only in the discharge cell that has undergone address discharge in the immediately preceding address period.
   This configuration can provide a plasma display apparatus where the forced initializing operation is omitted while the address operation is caused stably, the light emission that is not related to the gradation display is eliminated, and the contrast is largely improved.

The present invention can provide a driving method for a panel and a plasma display apparatus where a stable address discharge can be caused while sufficient voltage setting margin is secured and an image of high display quality can be displayed.

### BRIEF DESCRIPTION OF DRAWINGS

FIG. 1 is an exploded perspective view of a panel used in a plasma display apparatus in accordance with a first exemplary embodiment of the present invention.

FIG. 2 is an electrode array diagram of the panel used in the plasma display apparatus.

FIG. 3 is a diagram of driving voltage to be applied to each electrode of the plasma display apparatus.

FIG. 4A is a diagram showing a setting range of the voltage as a pulse wave height of a sustain pulse.

FIG. 4B is a diagram showing a setting range of the voltage as a pulse wave height of an address pulse.

FIG. 5 is a circuit block diagram of the plasma display apparatus in accordance with the first exemplary embodiment of the present invention.

FIG. 6 is a circuit diagram of a scan electrode driver circuit of the plasma display apparatus.

FIG. 7 is a circuit diagram of a sustain electrode driver circuit of the plasma display apparatus.

FIG. 8 is a waveform chart of driving voltage to be applied to each electrode of a plasma display apparatus in accordance with a second exemplary embodiment of the present invention.

FIG. 9 is a diagram illustrating the definition of first voltage, second voltage, and third voltage of the plasma display apparatus in accordance with the second exemplary embodiment.

FIG. 10 is a diagram showing one example of the method of measuring discharge start voltage of the plasma display apparatus in accordance with the second exemplary embodiment.

### DESCRIPTION OF EMBODIMENTS

Plasma display apparatuses in accordance with exemplary embodiments of the present invention will be described hereinafter with reference to the accompanying drawings.

### First Exemplary Embodiment

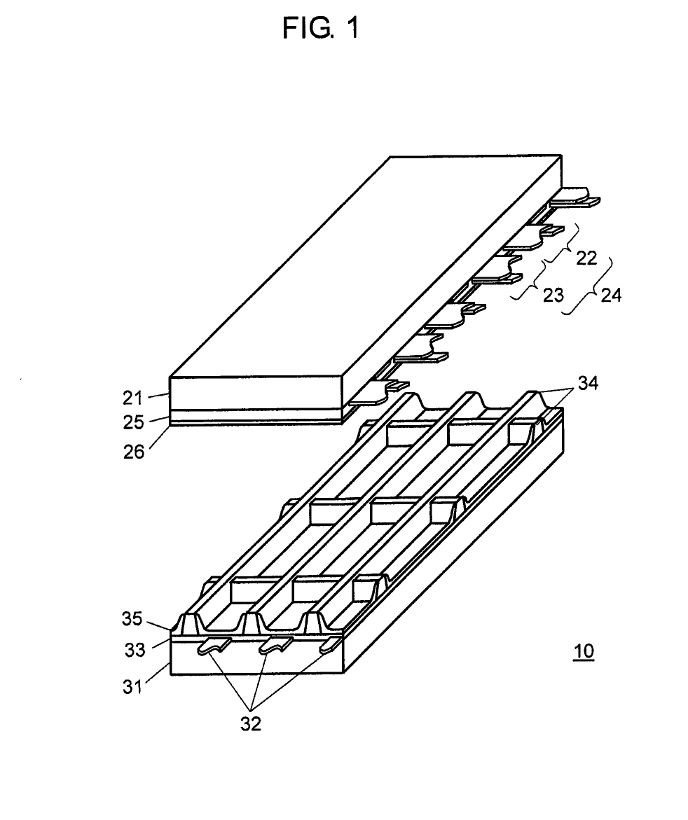

FIG. 1 is an exploded perspective view of panel 10 used in a plasma display apparatus in accordance with a first exemplary embodiment of the present invention. A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. Protective layer 26 is made of magnesium oxide, which is a material of high electron discharge performance, in order to facilitate the occurrence of discharge. A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of red, green, and blue are disposed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may be a structure having striped barrier ribs, for example.

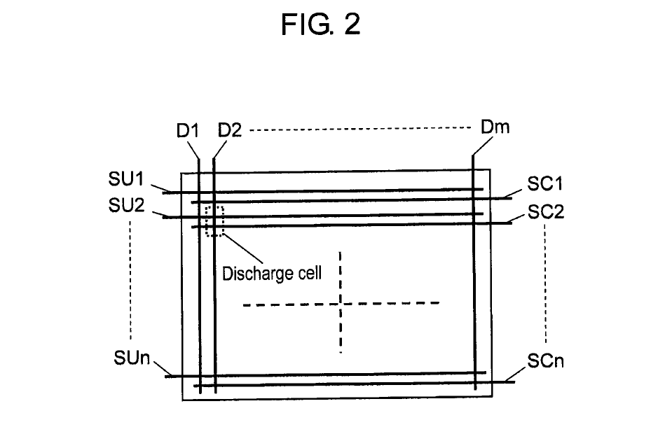

FIG. 2 is an electrode array diagram of panel 10 used in the plasma display apparatus in accordance with the first exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space.

Next, driving voltage and operation for driving panel 10 are described. The plasma display apparatus displays an image by a subfield method, in which the plasma display apparatus divides one field into a plurality of subfields, and controls light emission and no light emission of each discharge cell in each subfield.

Each subfield has an initializing period, an address period, and a sustain period. In the initializing period, initializing operation is performed that erases the history of the wall charge of the discharge cell before then and forms the wall charge required for the subsequent address discharge on each electrode. In the address period, address operation of selectively causing address discharge in the discharge cell to emit light and producing wall charge is performed. In the sustain period, sustain operation is performed that alternately applies as many sustain pulses as the number corresponding to a predetermined luminance weight to the display electrode pairs in each subfield, and causes sustain discharge to emit light in the discharge cell having undergone the address discharge. The sustain period may be omitted in order to suppress the emission luminance.

In this subfield structure, for example, one field is divided into 10 subfields (SF1, SF2, . . . , SF10), and respective subfields have luminance weights of (1, 2, 3, 6, 11, 18, 30, 44, 60, 80). Forced initializing operation is performed in the initializing period of SF1, and selective initializing operation is performed in the initializing period of SF2 through SF10. The present invention is not limited to the above-mentioned subfield structure such as the number of subfields or the luminance weight.

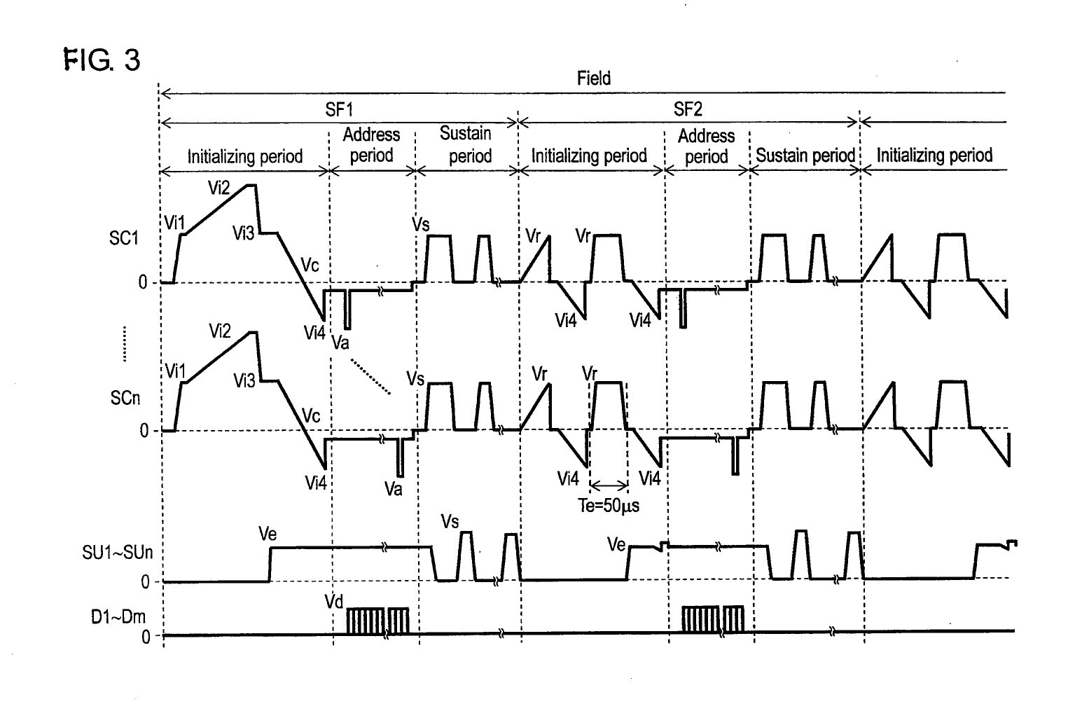

FIG. 3 is a diagram of driving voltage to be applied to each electrode of the plasma display apparatus in accordance with the first exemplary embodiment of the present invention.

In the initializing period of SF1, voltage 0 (V) is applied to data electrode D1 through data electrode Dm, and voltage 0 (V) is applied also to sustain electrode SU1 through sustain electrode SUn. An up-ramp waveform voltage is applied to scan electrode SC1 through scan electrode SCn. Here, the up-ramp waveform voltage gently increases from voltage Vi1, which is not higher than a discharge start voltage, to voltage Vi2, which is higher than the discharge start voltage, with respect to sustain electrode SU1 through sustain electrode SUn. Then, feeble initializing discharge occurs between scan electrode SC1 through scan electrode SCn and sustain electrode SU1 through sustain electrode SUn and between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrodes means voltage generated by the wall charge accumulated on the dielectric layer for covering the electrodes, the protective layer, or the phosphor layers.

Next, voltage Ve is applied to sustain electrode SU1 through sustain electrode SUn, and a down-ramp waveform voltage, which gently decreases from voltage Vi3 to voltage Vi4, is applied to scan electrode SC1 through scan electrode SCn. Then, feeble initializing discharge occurs again to reduce the wall voltage on scan electrode SC1 through scan electrode SCn and the wall voltage on sustain electrode SU1 through sustain electrode SUn. The excessive part of the wall voltage on data electrode D1 through data electrode Dm is discharged, and the wall voltage is adjusted to wall voltages appropriate for the address operation. Thus, the forced initializing operation of performing initializing discharge in all discharge cells is completed.

In the address period of SF1, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn.

Next, a scan pulse of voltage Va is applied to scan electrode SC1 of the first row, and an address pulse of voltage Vd is applied to data electrode Dk corresponding to the discharge cell to emit light. At this time, the voltage difference in the intersecting part of data electrode Dk and scan electrode SC1 is derived by adding positive wall voltage on data electrode Dk to difference (Vd−Va) of the external applied voltage, and exceeds the discharge start voltage. Discharge thus occurs between data electrode Dk and scan electrode SC1, and the discharge develops and causes address discharge between scan electrode SC1 and sustain electrode SU1. Positive wall voltage is then accumulated on scan electrode SC1, negative wall voltage is accumulated on sustain electrode SU1, and negative wall voltage is also accumulated on data electrode Dk. Thus, the address operation of causing the address discharge in the discharge cell to emit light in the first row and accumulating wall voltage on each electrode is performed. While, the voltage in the part where scan electrode SC1 intersects with data electrode Dh to which no address pulse has been applied does not exceed the discharge start voltage, so that address discharge does not occur.

Next, a scan pulse is applied to scan electrode SC2 of the second row, and an address pulse is applied to data electrode Dk corresponding to the discharge cell to emit light. At this time, address discharge occurs between data electrode Dk and scan electrode SC2 and between sustain electrode SU2 and scan electrode SC2, positive wall voltage is accumulated on scan electrode SC2, negative wall voltage is accumulated on sustain electrode SU2, and negative wall voltage is also accumulated on data electrode Dk. Thus, address operation of causing address discharge in the discharge cell to emit light in the second row and accumulating wall voltage on each electrode is performed. The voltage in the part where scan electrode SC2 intersects with data electrode Dh to which no address pulse has been applied does not exceed the discharge start voltage, so that address discharge does not occur.

Similar address operation is performed until it reaches scan electrode SCn of the n-th row, thereby producing the wall charge required for subsequent sustain discharge.

In the sustain period of SF1, voltage 0 (V) is applied to sustain electrode SU1 through sustain electrode SUn, and a sustain pulse of voltage Vs is applied to scan electrode SC1 through scan electrode SCn. In the discharge cell having undergone the address discharge, the voltage difference between scan electrode SCi and sustain electrode SUi is derived by adding the difference between the wall voltage on scan electrode SCi and that on sustain electrode SUi to voltage Vs, and exceeds the discharge start voltage between scan electrode SCi and sustain electrode SUi. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge, sustain discharge occurs again and phosphor layer 35 emits light. Therefore, negative wall voltage is accumulated on sustain electrode SUi, and positive wall voltage is accumulated on scan electrode SCi.

Hereinafter, similarly, as many sustain pulses as the number corresponding to the luminance weight are alternately applied to scan electrode SC1 through scan electrode SCn and sustain electrode SU1 through sustain electrode SUn to continuously cause sustain discharge in the discharge cell having undergone the address discharge.

In the subsequent initializing period of SF2, voltage 0 (V), which is first voltage, is applied to sustain electrode SU1 through sustain electrode SUn, and an up-ramp waveform voltage, which gently increases from voltage 0 (V) to voltage Vr, is applied to scan electrode SC1 through scan electrode SCn. In the present embodiment, voltage Vr is set to be the same as voltage Vs. In the discharge cell having undergone the sustain discharge (the discharge cell having undergone the address discharge in the case where the sustain period is omitted), first feeble erasing discharge occurs where scan electrode SCi is used as the positive electrode and sustain electrode SUi is used as the negative electrode. The wall voltages on scan electrodes SCi and on sustain electrodes SUi are reduced.

Next, in a state where voltage 0 (V) is applied to sustain electrode SU1 through sustain electrode SUn, and a down-ramp waveform voltage, which gently decreases from voltage 0 (V) to voltage Vi4, is applied to scan electrode SC1 through scan electrode SCn. This down-ramp waveform voltage is the first down-ramp waveform voltage. At this time, feeble discharge occurs again in the discharge cell having undergone feeble erasing discharge. The feeble discharge at this time is the first discharge where the scan electrode is used as the negative electrode and the data electrode is used as the positive electrode. Voltage Vi4 is set to be equal to or slightly higher than voltage Va of the scan pulse.

Then, a rectangular voltage of voltage Vr is applied to scan electrode SC1 through scan electrode SCn for period Te. Third discharge occurs in the discharge cell having undergone the feeble erasing discharge. The discharge at this time is the second discharge where the scan electrode is used as the positive electrode and the sustain electrode is used as the negative electrode. The discharge at this time becomes weak. This is because the discharge is caused by applying the ramp waveform voltage, which increases to voltage Vr, to the scan electrode to cause discharge, and then applying voltage Vr to the scan electrode again without causing discharge where the scan electrode is used as the negative electrode and the sustain electrode is used as the positive electrode.

Then, voltage Ve, which is the second voltage higher than the first voltage, is applied to sustain electrode SU1 through sustain electrode SUn, and a down-ramp waveform voltage, which gently decreases from voltage 0 (V) to voltage Vi4, is applied to scan electrode SC1 through scan electrode SCn. This down-ramp waveform voltage is the second down-ramp waveform voltage. At this time, fourth feeble discharge occurs in the discharge cell having undergone discharge. The discharge at this time is the second discharge where the scan electrode is used as the negative electrode and the data electrode is used as the positive electrode. Discharge also occurs where the scan electrode is used as the negative electrode and the sustain electrode is used as the positive electrode. The excessive part of the wall voltage on scan electrode SCi, that on sustain electrode SUi, and that on data electrode Dk is discharged by the feeble discharge, and these wall voltages are adjusted to wall voltages appropriate for the address operation. Thus, the initializing operation is completed.

The discharge at this time is caused by the gently decreasing a down-ramp waveform voltage. Therefore, the caused discharge becomes feeble, the wall voltage on scan electrode SCi, that on sustain electrode SUi, and that on data electrode Dk are adjusted extremely accurately. Thus, when the discharge is caused using the gentle ramp waveform voltage after the discharge caused using rectangular voltage, the wall voltages can be adjusted accurately, and subsequent address discharge can be stably caused.

The operation in the address period of subsequent SF2 is similar to the operation in the address period of SF1. The operation in the sustain period of SF2 is similar to the operation in the sustain period of SF1 except for the number of sustain pulses. Each operation of SF3 through SF10 is similar to the operation of SF2 except for the number of sustain pulses.

In the present embodiment, voltage Vi1 is voltage 200 (V), voltage Vi2 is voltage 400 (V), voltage Vi3 is voltage 200 (V), voltage Vi4 is voltage −180 (V), voltage Vc is voltage −55 (V), voltage Va is voltage −200 (V), voltage Vs is voltage 200 (V), and voltage Vr is voltage 200 (V), voltage Ve is voltage 150 (V), and voltage Vd is voltage 60 (V). The period Te is 50 μs. However, these voltage values are not limited to the above-mentioned values, and preferably are set optimally based on the discharge characteristic of the panel and the specification of the plasma display apparatus.

In the present embodiment, the following processes are performed in the initializing period:
causing first discharge where sustain electrode SUi is used as the negative electrode and scan electrode SCi is used as the positive electrode;
then, causing first discharge where scan electrode SCi is used as the negative electrode and data electrode Dk is used as the positive electrode;
then, causing second discharge where sustain electrode SUi is used as the negative electrode and scan electrode SCi is used as the positive electrode; and
then, causing second discharge where scan electrode SCi is used as the negative electrode and data electrode Dk is used as the positive electrode. In order to reduce these discharges and suppress light emission caused by the discharges, the following processes are performed:
applying voltage 0 (V) as the first voltage to sustain electrode SU1 through sustain electrode SUn and applying an up-ramp waveform voltage whose gradient is 10 (V/μs) to scan electrode SC1 through scan electrode SCn;
then, applying a first down-ramp waveform voltage whose gradient is −1.5 (V/μs) to scan electrode SC1 through scan electrode SCn;
then, applying a positive rectangular voltage whose rising time is equal to or less than 1 (μs) to scan electrode SC1 through scan electrode SCn; and
then, applying voltage Ve, which is the second voltage higher than the first voltage, to sustain electrode SU1 through sustain electrode SUn and applying a second down-ramp waveform voltage whose gradient is −1.5 (μs) to scan electrode SC1 through scan electrode SCn.

Thus, even when strong discharge is not caused, by repeatedly causing feeble discharge a plurality of times, sufficient wall voltage can be accumulated on each electrode and subsequent address discharge can be stably caused.

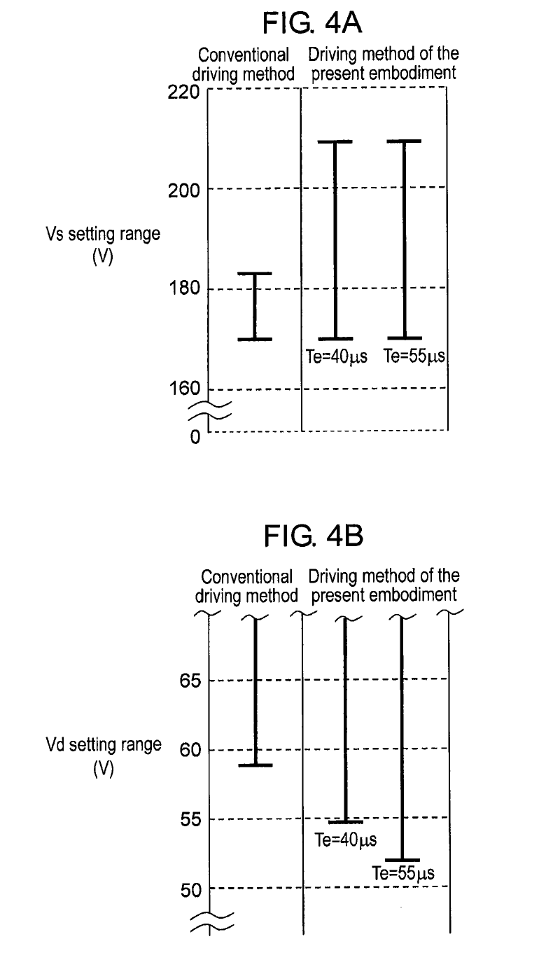

FIG. 4 shows an experimental result obtained by measuring a voltage setting margin by a conventional driving method disclosed in Patent Literature 2 and a voltage setting margin by a driving method of the present embodiment. FIG. 4A shows a setting range of voltage Vs as a pulse wave height of a sustain pulse. FIG. 4B shows a setting range of voltage Vd as a pulse wave height of an address pulse.

As shown in FIG. 4A, the setting range of voltage Vs by the conventional driving method is voltage 170 (V) to voltage 183 (V), and the setting range of voltage Vs by the driving method of the present embodiment is voltage 170 (V) to voltage 210 (V). The voltage setting margin is extremely larger in the driving method of the present embodiment than in the conventional driving method.

The reason why the driving margin is larger in the driving method of the present embodiment is considered as follows, for example. In the sustain period, a sustain pulse is alternately applied to scan electrode SC1 through scan electrode SCn and sustain electrode SU1 through sustain electrode SUn, and then an up-ramp waveform voltage increasing to voltage Vr is applied to scan electrode SC1 through scan electrode SCn, thereby causing erasing discharge. At this time, in order to cause the erasing discharge only in the discharge cell having undergone the sustain discharge, voltage Vr cannot be set to be so high and needs to be set close to voltage Vs. In the discharge at this time, the history of the wall voltage by the sustain discharge cannot be erased completely, but the wall charge accumulated by the sustain discharge remains. In the conventional driving method, the remaining wall voltage is added to the sustain pulse. Therefore, the possibility becomes high that the sustain discharge in the subsequent sustain period is caused even in the discharge cell that has not undergone address operation in the address period after the selective initializing operation. Therefore, voltage Vs cannot be set to be high.

In the driving method of the present embodiment, however, a sustain pulse is alternately applied to scan electrode SC1 through scan electrode SCn and sustain electrode SU1 through sustain electrode SUn in the sustain period. Then, discharge where sustain electrode SUi is used as the negative electrode and scan electrode SCi is used as the positive electrode and discharge where scan electrode SCi is used as the negative electrode and data electrode Dk is used as the positive electrode are caused alternately two times. Therefore, the history of the wall voltage by the sustain discharge is erased, sustain discharge does not occur in the discharge cell having undergone no address operation in the address period, and voltage Vs can be set to be high.

As shown in FIG. 4B, the lower limit of the setting range of voltage Vd by the conventional driving method is voltage 58 (V), and the lower limit of the setting range of voltage Vd by the driving method of the present embodiment is voltage 55 (V) when period Te is 40 μs or voltage 52 (V) when period Te is 55 μs. Thus, in the driving method of the present embodiment, the voltage setting margin of voltage Vd is larger than in the conventional driving method. Even when voltage Vd is set at the upper limit voltage of the withstand voltage of a data electrode driver circuit, the driver circuit operates normally both in the driving method of the present embodiment and in the conventional driving method.

Thus, in the driving method of the panel of the first exemplary embodiment of the present invention, the voltage setting margins of voltage Vs and voltage Vd can be set to be larger than in the conventional driving method of the panel. In addition, the voltage setting margin of the pulse wave height or the like of the scan pulse can be enlarged. The setting range of voltage Vd and the setting range of the pulse wave height or the like of the scan pulse depend on period Te in which the rectangular voltage of voltage Vr is applied to scan electrode SC1 through scan electrode SCn. The voltage setting margins are also apt to enlarge as period Te is set to be longer. Practically, when period Te is set at about 50 μs, sufficient voltage setting margin can be secured.

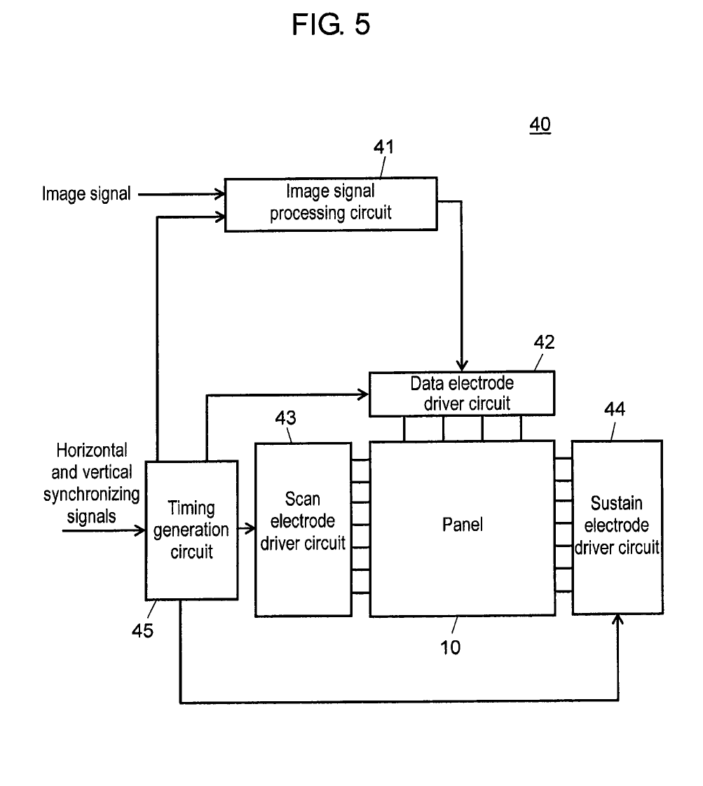

Next, a driver circuit for driving panel 10 is described. FIG. 5 is a circuit block diagram of plasma display apparatus 40 in accordance with the first exemplary embodiment of the present invention. Plasma display apparatus 40 has panel 10 and a driver circuit thereof. The driver circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying required power to each circuit block.

Image signal processing circuit 41 converts an input image signal into image data that indicates light emission or no light emission in each subfield. Data electrode driver circuit 42 converts the image data in each subfield into an address pulse corresponding to each of data electrode D1 through data electrode Dm, and applies it to each of data electrode D1 through data electrode Dm. Timing generation circuit 45 generates various timing signals for controlling operations of respective circuit blocks based on a vertical synchronizing signal and a horizontal synchronizing signal, and supplies the timing signals to respective circuit blocks. Scan electrode driver circuit 43 generates the above-mentioned driving voltage based on the timing signals, and applies it to each of scan electrode SC1 through scan electrode SCn. Sustain electrode driver circuit 44 generates the driving voltage based on the timing signals, and applies it to sustain electrode SU1 through sustain electrode SUn.

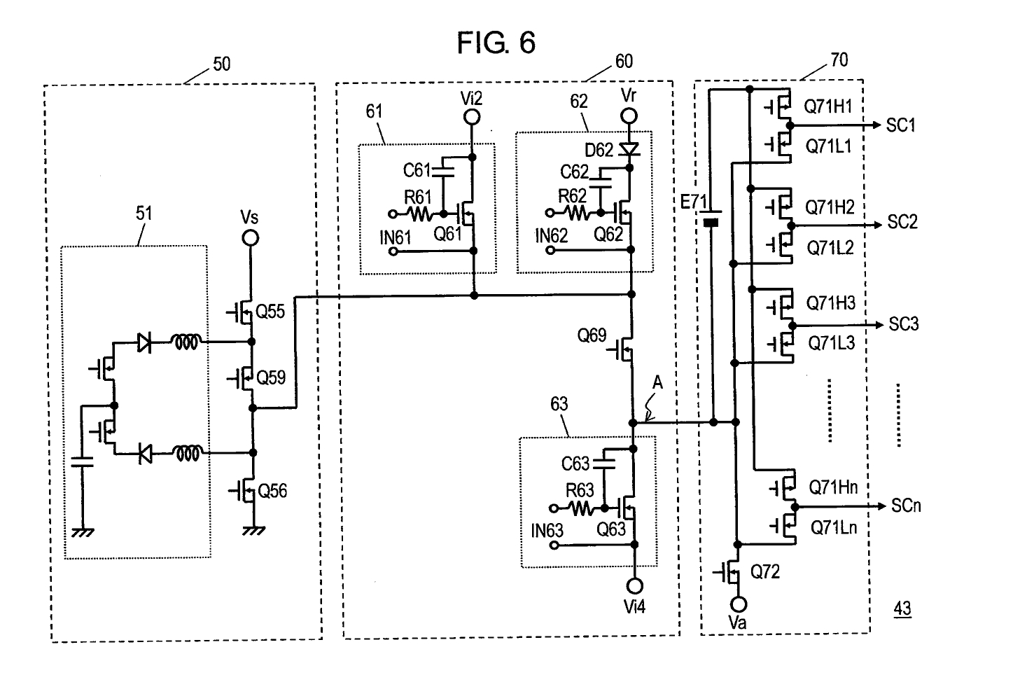

FIG. 6 is a circuit diagram of scan electrode driver circuit 43 of plasma display apparatus 40 in accordance with the first exemplary embodiment of the present invention. Scan electrode driver circuit 43 has sustain pulse generation circuit 50, ramp waveform voltage generation circuit 60, and scan pulse generation circuit 70.

Sustain pulse generation circuit 50 has power recovery circuit 51, switching element Q55, switching element Q56, and switching element Q59, and generates sustain pulses to be applied to scan electrode SC1 through scan electrode SCn. Power recovery circuit 51 recovers electric power in driving scan electrode SC1 through scan electrode SCn, and reuses it. Switching element Q55 clamps scan electrode SC1 through scan electrode SCn on voltage Vs, and switching element Q56 clamps scan electrode SC1 through scan electrode SCn on voltage 0 (V). Switching element Q59 is a separation switch, and prevents current from flowing back via a parasitic diode or the like of the switching element that is included in scan electrode driver circuit 43.

Scan pulse generation circuit 70 has switching elements Q71H1 through Q71Hn, switching elements Q71L1 through Q71Ln, and switching element Q72. A scan pulse is generated using a power supply of voltage Va and using power supply E71 of voltage (Vc−Va) superimposed on the reference potential (potential at node A shown in FIG. 6) of scan pulse generation circuit 70. A scan pulse is sequentially applied to scan electrode SC1 through scan electrode SCn with the timings shown in FIG. 3. Scan pulse generation circuit 70 outputs the output voltage of sustain pulse generation circuit 50 as it is during sustain operation. In other words, scan pulse generation circuit 70 outputs the voltage at node A to scan electrode SC1 through scan electrode SCn.

Ramp waveform voltage generation circuit 60 has Miller integrating circuit 61, Miller integrating circuit 62, and Miller integrating circuit 63, and generates the ramp waveform voltage shown in FIG. 3. Miller integrating circuit 61 has transistor Q61, capacitor C61, and resistor R61, and applies a fixed voltage to input terminal IN61 to generate an up-ramp waveform voltage that gently increases to voltage Vit. Miller integrating circuit 62 has transistor Q62, capacitor C62, resistor R62, and diode D62 for preventing current from flowing back, and applies a fixed voltage to input terminal IN62 to generate an up-ramp waveform voltage that gently increases to voltage Vr. Miller integrating circuit 63 has transistor Q63, capacitor C63, and resistor R63, and applies a fixed voltage to input terminal IN63 to generate a down-ramp waveform voltage that gently decreases to voltage Vi4. Switching element Q69 is also a separation switch, and prevents current from flowing back via a parasitic diode or the like of the switching element that is included in scan electrode driver circuit 43.

These switching elements and transistors can be formed of generally known elements such as a metal oxide semiconductor field effect transistor (MOSFET) or an insulated gate bipolar transistor (IGBT). These switching elements and transistors are controlled with timing signals that are generated in timing generation circuit 45 and correspond to the switching elements and transistors.

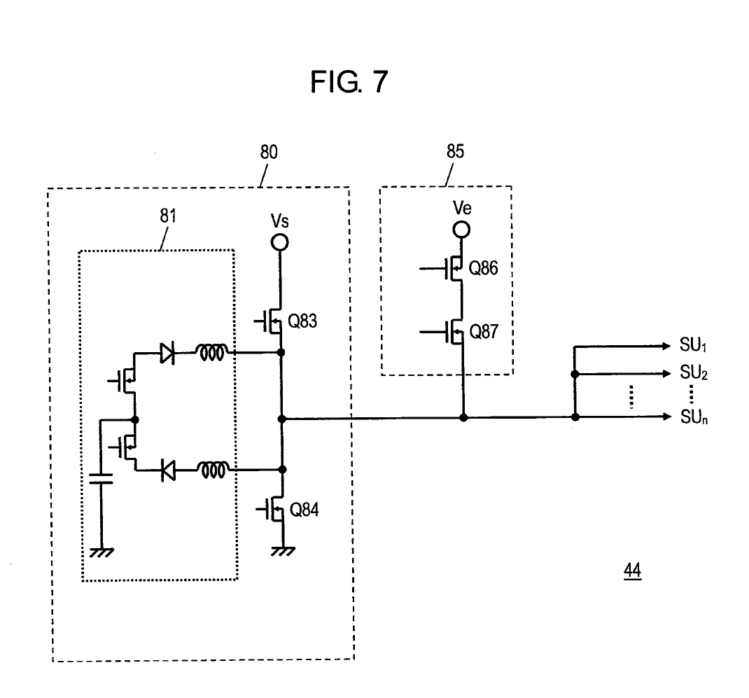

FIG. 7 is a circuit diagram of sustain electrode driver circuit 44 of plasma display apparatus 40 in accordance with the first exemplary embodiment of the present invention. Sustain electrode driver circuit 44 has sustain pulse generation circuit 80 and fixed voltage generation circuit 85.

Sustain pulse generation circuit 80 has power recovery circuit 81, switching element Q83, and switching element Q84, and generates a sustain pulse to be applied to sustain electrode SU1 through sustain electrode SUn. Power recovery circuit 81 recovers electric power in driving sustain electrode SU1 through sustain electrode SUn, and reuses it. Switching element Q83 clamps sustain electrode SU1 through sustain electrode SUn on voltage Vs, and switching element Q84 clamps sustain electrode SU1 through sustain electrode SUn on voltage 0 (V).

Fixed voltage generation circuit 85 has switching element Q86 and switching element Q87, and applies voltage Ve to sustain electrode SU1 through sustain electrode SUn.

These switching elements can be also formed using generally known elements such as a MOSFET or an IGBT. These switching elements are controlled with timing signals that are generated in timing generation circuit 45 and correspond to the switching elements.

A method of generating driving voltage to be applied to scan electrode SC1 through scan electrode SCn and sustain electrode SU1 through sustain electrode SUn in the initializing period of SF2 is described using scan electrode driver circuit 43 of FIG. 6 and sustain electrode driver circuit 44 of FIG. 7. Also here, voltage Vr is set to be the same as voltage Vs.

In order to apply voltage 0 (V) to sustain electrode SU1 through sustain electrode SUn, switching element Q84 is set at ON. In order to apply an up-ramp waveform voltage, which gently increases to voltage Vr, to scan electrode SC1 through scan electrode SCn, switching elements Q71L1 through Q71Ln and switching element Q69 are set at ON, and voltage is applied to input terminal IN62 to operate Miller integrating circuit 62.

Next, in order to apply a down-ramp waveform voltage, which gently decreases from voltage 0 (V) to voltage Vi4, to scan electrode SC1 through scan electrode SCn, transistor Q62 of Miller integrating circuit 62 is set at OFF and switching element Q56 is set at ON to apply voltage 0 (V) to scan electrode SC1 through scan electrode SCn. Switching element Q56 and switching element Q69 are set at OFF, and voltage is applied to input terminal IN63 to operate Miller integrating circuit 63.

Then, in order to apply rectangular voltage of voltage Vr to scan electrode SC1 through scan electrode SCn, transistor Q63 of Miller integrating circuit 63 is set at OFF and switching element Q69, switching element Q59, and switching element Q55 are set at ON.

Then, in order to apply voltage Ve to sustain electrode SU1 through sustain electrode SUn, switching element Q84 is set at OFF, and switching element Q86 and switching element Q87 are set at ON. In order to apply a down-ramp waveform voltage, which gently decreases from voltage 0 (V) to voltage Vi4, to scan electrode SC1 through scan electrode SCn, transistor Q62 of Miller integrating circuit 62 is set at OFF and switching element Q56 is set at ON to apply voltage 0 (V) to scan electrode SC1 through scan electrode SCn. Switching element Q56 and switching element Q69 are set at OFF, and voltage is applied to input terminal IN63 to operate Miller integrating circuit 63.

Immediately before the voltage of scan electrode SC1 through scan electrode SCn arrives at voltage Vi4, switching element Q86 and switching element Q87 of sustain electrode driver circuit 44 may be set at OFF to put sustain electrode SU1 through sustain electrode SUn into a high impedance state. Such driving allows the subsequent address operation to be caused further stably. FIG. 3 shows such driving voltage.

Thus, the driving voltage of the panel of FIG. 3 can be generated. The driver circuits shown in FIG. 5 through FIG. 7 are one example, the present invention is not limited to the configurations of these driver circuits.

### Second Exemplary Embodiment

The driver circuit of a panel and a plasma display apparatus of a second exemplary embodiment is similar to that of panel 10 and plasma display apparatus 40 of the first exemplary embodiment, and hence is not described in detail.

A driving voltage waveform and operation for driving panel 10 of the second exemplary embodiment are described. The plasma display apparatus displays an image by the subfield method. In this method, one field is divided into a plurality of subfields, and light emission and no light emission of each discharge cell in each subfield is controlled.

In the present exemplary embodiment, each subfield has an address period, a sustain period, and an erasing period. In the present exemplary embodiment, the forced initializing operation of forcibly causing initializing discharge regardless of previous existence of discharge is not performed.

In the address period, address operation of selectively causing address discharge in the discharge cell to emit light to produce wall charge is performed. In the sustain period, sustain operation is performed that alternately applies as many sustain pulses as the number corresponding to a predetermined luminance weight to the display electrode pairs in each subfield and causes sustain discharge to emit light in the discharge cell that has undergone the address discharge. The sustain period may be omitted in order to suppress the emission luminance. In the erasing period, erasing operation is performed that selectively causes the erasing discharge only in the discharge cell that has undergone address discharge in the immediately preceding address period, erases the history of the wall charge produced by address discharge or the subsequent sustain discharge, and produces the wall charge required for the subsequent address discharge on each electrode.

In this subfield structure, for example, one field is divided into 10 subfields (SF1, SF2, . . . , SF10), and respective subfields have luminance weights of (1, 2, 3, 6, 11, 18, 30, 44, 60, 80). The present invention is not limited to the above-mentioned subfield structure such as the number of subfields or the luminance weight.

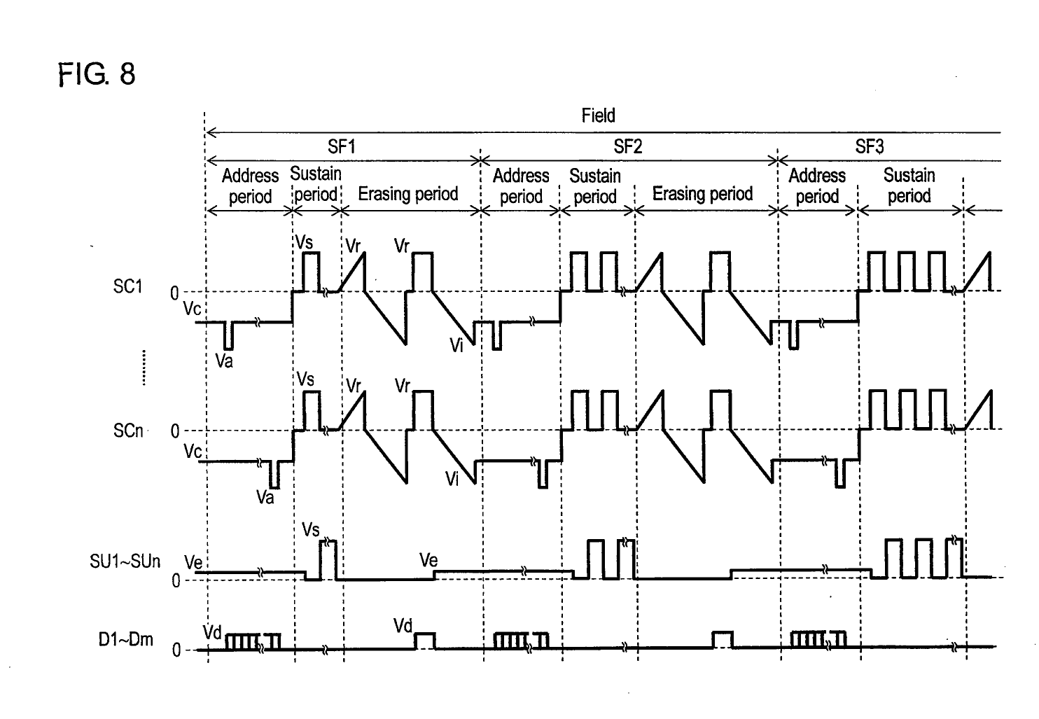

FIG. 8 is a waveform chart of driving voltage to be applied to each electrode of the plasma display apparatus in accordance with the second exemplary embodiment of the present invention.

In the address period of SF1, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn. Next, a scan pulse of voltage Va is applied to scan electrode SC1 of the first row, and an address pulse of voltage Vd is applied to data electrode Dk corresponding to the discharge cell to emit light.

At this time, the voltage difference in the intersecting part of data electrode Dk and scan electrode SC1 is derived by adding positive wall voltage on data electrode Dk to difference (Vd−Va) of the external applied voltage, and exceeds discharge start voltage VFds. Discharge thus occurs between data electrode Dk and scan electrode SC1. Therefore, the discharge occurring between data electrode Dk and scan electrode SC1 develops and causes address discharge between scan electrode SC1 and sustain electrode SU1. Thus, positive wall voltage is accumulated on scan electrode SC1, negative wall voltage is accumulated on sustain electrode SU1, and negative wall voltage is also accumulated on data electrode Dk. Here, the wall voltage on the electrodes shows voltage generated by the wall charge accumulated on the dielectric layer for covering the electrodes, the protective layer, and the phosphor layer.

Thus, address operation of causing address discharge in the discharge cell to emit light in the first row and accumulating wall voltage on each electrode is performed. The voltage in the part where scan electrode SC1 intersects with data electrode Dh to which no address pulse is applied does not exceed discharge start voltage VFds, so that address discharge does not occur.

Next, a scan pulse is applied to scan electrode SC2 of the second row, and an address pulse is applied to data electrode Dk corresponding to the discharge cell to emit light. At this time, address discharge occurs between data electrode Dk and scan electrode SC2 and between sustain electrode SU2 and scan electrode SC2. Thus, positive wall voltage is accumulated on scan electrode SC2, negative wall voltage is accumulated on sustain electrode SU2, and negative wall voltage is also accumulated on data electrode Dk. Thus, address operation of causing address discharge in the discharge cell to emit light in the second row and accumulating wall voltage on each electrode is performed. The voltage in the part where scan electrode SC2 intersects with data electrode Dh to which no address pulse has been applied does not exceed discharge start voltage VFds, so that address discharge does not occur.

Similar address operation is performed until it reaches scan electrode SCn of the n-th row, thereby producing the wall charge required for the subsequent sustain discharge.

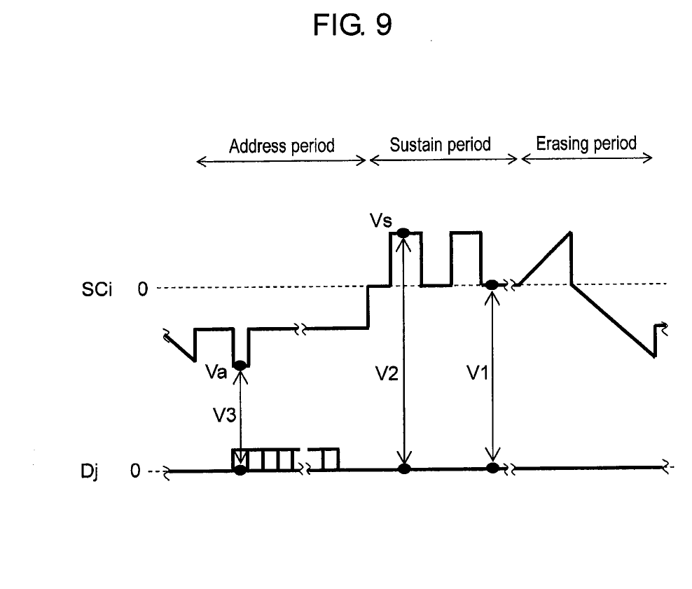

For later description, first voltage V1, second voltage V2, and third voltage V3 are defined as in FIG. 9. First voltage V1 is assumed to be the voltage derived by subtracting the voltage applied to data electrode Dj from the low-side voltage of the sustain pulse applied to scan electrode SCi in the sustain period discussed later. Second voltage V2 is assumed to be the voltage derived by subtracting the voltage applied to data electrode Dj from the high-side voltage of the sustain pulse applied to scan electrode SCi in the sustain period. Third voltage V3 is assumed to be the voltage derived by subtracting the low-side voltage of the address pulse applied to data electrode Dj from the low-side voltage of the scan pulse applied to scan electrode SCi in the address period.

The discharge start voltage where data electrode Dj is used as the positive electrode and scan electrode SCi is used as the negative electrode is assumed to be discharge start voltage VFds. The discharge start voltage where data electrode Dj is used as the negative electrode and scan electrode SCi is used as the positive electrode is assumed to be discharge start voltage VFsd. In the discharge where data electrode Dj is used as the positive electrode and scan electrode SCi is used as the negative electrode, data electrode Dj exists on the high potential side and scan electrode SCi exists on the low potential side in the electric field in the discharge cell when the discharge occurs. In the discharge where data electrode Dj is used as the negative electrode and scan electrode SCi is used as the positive electrode, data electrode Dj exists on the low potential side and scan electrode SCi exists on the high potential side in the electric field in the discharge cell when the discharge occurs. Protective layer 26 made of magnesium oxide of high electron discharge performance is formed on the scan electrode SCi side, so that discharge start voltage VFds is lower than discharge start voltage VFsd.

At this time, voltage Va of the scan pulse applied to scan electrode SCi is set so as to satisfy the following two conditions (Condition 1) and (Condition 2).

(Condition 1) In all discharge cells, the voltage derived by subtracting third voltage V3 from first voltage V1 is not lower than discharge start voltage VFds where data electrode Dj is used as the positive electrode and scan electrode SCi is used as the negative electrode, namely (V1−V3)≧VFds is satisfied.

(Condition 2) In all discharge cells, the voltage derived by subtracting third voltage V3 from second voltage V2 does not exceed the sum of discharge start voltage VFds where data electrode Dj is used as the positive electrode and scan electrode SCi is used as the negative electrode and discharge start voltage VFsd where data electrode Dj is used as the negative electrode and scan electrode SCi is used as the positive electrode, namely (V2−V3)≦VFds+VFsd) is satisfied.

In the subsequent sustain period of SF1 after the address period, voltage 0 (V) is applied to sustain electrode SU1 through sustain electrode SUn, and a sustain pulse of voltage Vs is applied to scan electrode SC1 through scan electrode SCn. In the discharge cell that has undergone the address discharge, the voltage difference between scan electrode SCi and sustain electrode SUi is derived by adding the difference between the wall voltage on scan electrode SCi and that on sustain electrode SUi to voltage Vs, and exceeds discharge start voltage VFss between scan electrode SCi and sustain electrode SUi. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge, sustain discharge occurs again and phosphor layer 35 emits light. Therefore, negative wall voltage is accumulated on sustain electrode SUi, and positive wall voltage is accumulated on scan electrode SCi. Hereinafter, similarly, as many sustain pulses as the number corresponding to the luminance weight are alternately applied to scan electrode SC1 through scan electrode SCn and sustain electrode SU1 through sustain electrode SUn to continuously cause sustain discharge in the discharge cell that has undergone the address discharge.

In the subsequent erasing period of SF1, voltage 0 (V) as the fourth voltage is applied to sustain electrode SU1 through sustain electrode SUn, and an up-ramp waveform voltage, which gently increases to voltage Vr, is applied to scan electrode SC1 through scan electrode SCn. In the present embodiment, voltage Vr is set to be the same as voltage Vs. In the discharge cell having undergone the sustain discharge (the discharge cell having undergone the address discharge in the case where the sustain period is omitted), first feeble erasing discharge occurs where scan electrode SCi is used as the positive electrode and sustain electrode SUi is used as the negative electrode. The wall voltage on scan electrode SCi and the wall voltage on sustain electrode SUi are reduced.

Next, in a state where voltage 0 (V) is applied to sustain electrode SU1 through sustain electrode SUn, a down-ramp waveform voltage, which gently decreases from voltage 0 (V) to voltage Vi4, is applied to scan electrode SC1 through scan electrode SCn. At this time, feeble discharge occurs again in the discharge cell having undergone feeble erasing discharge. The feeble discharge at this time is the first discharge where scan electrode SCi is used as the negative electrode and data electrode Dk is used as the positive electrode. Voltage Vi4 is set to be equal to or slightly higher than voltage Va of the scan pulse.

Then, a rectangular voltage of voltage Vr is applied to scan electrode SC1 through scan electrode SCn. Third discharge occurs in the discharge cell having undergone the feeble erasing discharge. The discharge at this time is the second discharge where scan electrode SCi is used as the positive electrode and sustain electrode SUi is used as the negative electrode. The discharge at this time is weak.

Then, voltage Ve, which is the fifth voltage higher than the fourth voltage 0 (V), is applied to sustain electrode SU1 through sustain electrode SUn, and a down-ramp waveform voltage, which gently decreases from voltage 0 (V) to voltage Vi4, is applied to scan electrode SC1 through scan electrode SCn. At this time, fourth feeble discharge occurs in the discharge cell having undergone discharge. The discharge at this time is the second discharge where scan electrode SCi is used as the negative electrode and data electrode Dk is used as the positive electrode. The excessive part of the wall voltage on scan electrode SCi, that on sustain electrode SUi, and that on data electrode Dk is discharged by the feeble discharge, and these wall voltages are adjusted to wall voltages appropriate for the address operation. Thus, the erasing operation is completed.

Each operation of subsequent SF2 through SF10 is similar to the operation of the SF1 except for the number of sustain pulses.

In the present embodiment, in the erasing period of all subfields, the erasing discharge is caused only in the discharge cell that has undergone address discharge in the immediately preceding address period. In the present embodiment, discharge does not occur in the discharge cell having undergone no address discharge, and hence light emission does not occur in the discharge cell to display black.

In the present embodiment, similarly to the first embodiment, voltage Vi4 is voltage −260 (V), voltage Vc is voltage −145 (V), voltage Va is voltage −280 (V), voltage Vs is voltage 200 (V), voltage Vr is voltage 200 (V), voltage Ve is voltage 20 (V), and voltage Vd is voltage 60 (V). However, these voltage values are not limited to the above-mentioned values, and, preferably, are set optimally based on the discharge characteristic of the panel and the specification of the plasma display apparatus.

Discharge start voltage VFds and discharge start voltage VFsd of panel 10 used in the present embodiment are measured by the method described later, and have the following values. The discharge start voltages depend on the phosphor. Discharge start voltage VFds and discharge start voltage VFsd between “data electrode and scan electrode” for the discharge cell coated with a red phosphor are voltage 200±10 (V) and voltage 320±10 (V), respectively. Discharge start voltage VFds and discharge start voltage VFsd between “data electrode and scan electrode” for the discharge cell coated with a green phosphor are voltage 220±10 (V) and voltage 350±10 (V), respectively. Discharge start voltage VFds and discharge start voltage VFsd between “data electrode and scan electrode” for the discharge cell coated with a blue phosphor are voltage 200±10 (V) and voltage 330±10 (V), respectively. Discharge start voltage VFss between “scan electrode and sustain electrode” is voltage 250±10 (V) for the discharge cells coated with red and blue phosphors, and voltage 280±10 (V) for the discharge cell coated with a green phosphor.

In the present embodiment, the voltage on the low voltage side of the sustain pulse is voltage 0 (V) and the voltage applied to the data electrode in the sustain period is voltage 0 (V), so that first voltage V1 is voltage 0 (V). The voltage on the low voltage side of the scan pulse is voltage Va and the voltage on the low voltage side of the address pulse is voltage 0 (V), so that third voltage V3 is voltage Va. The maximum value of discharge start voltage VFds is voltage 230 (V) in consideration of variation. Therefore, (first voltage V1−third voltage V3)=−Va >(maximum value of voltage VFds), namely 280 (V)>230 (V). Therefore, (Condition 1) is satisfied in all discharge cells.

The voltage on the high voltage side of the sustain pulse is voltage Vs and the voltage applied to the data electrode in the sustain period is voltage 0 (V), so that second voltage V2 is voltage Vs. The minimum value of the sum of discharge start voltage VFsd and discharge start voltage VFds is voltage 500 (V). Therefore, (second voltage V2−third voltage V3)=Vs−Va<minimum value of (VFds+VFsd), namely 480 (V) <500 (V). Therefore, (Condition 2) is also satisfied in all discharge cells.

As is clear from the above-mentioned voltages, voltage that is low-side voltage Va of the scan pulse or higher and is high-side voltage Vs of the sustain pulse or lower is applied to the scan electrode, and voltage lower than low-side voltage Va of the scan pulse or voltage higher than high-side voltage Vs of the sustain pulse is not applied. Therefore, light is not emitted in the discharge cell having undergone no address discharge.

As is clear from the above-mentioned voltages, when voltage Va is set to be low so as to satisfy (Condition 1), absolute value |Va| of low-side voltage Va of the scan pulse is larger than absolute value |Vs| of high-side voltage Vs of the sustain pulse.

Thus, in the present embodiment, a driving voltage waveform to be applied to each electrode, especially voltage Va of the scan pulse, is set so as to satisfy (Condition 1) and (Condition 2). In other words, in the erasing period, the erasing discharge is selectively caused only in the discharge cell that has undergone address discharge in the immediately preceding address period. The voltage derived by subtracting third voltage V3 from first voltage V1 is not lower than discharge start voltage VFds where data electrode Dj is used as the positive electrode and scan electrode SCi is used as the negative electrode. The voltage derived by subtracting third voltage V3 from second voltage V2 does not exceed the sum of discharge start voltage VFds where data electrode Dj is used as the positive electrode and scan electrode SCi is used as the negative electrode and discharge start voltage VFsd where data electrode Dj is used as the negative electrode and scan electrode SCi is used as the positive electrode. Here, first voltage V1 is assumed to be the voltage derived by subtracting the voltage applied to data electrode Dj from the low-side voltage of the sustain pulse applied to scan electrode SCi in the sustain period. Second voltage V2 is assumed to be the voltage derived by subtracting the voltage applied to data electrode Dj from the high-side voltage of the sustain pulse applied to scan electrode SCi in the sustain period. Third voltage V3 is assumed to be the voltage derived by subtracting the low-side voltage of the address pulse applied to data electrode Dj from the low-side voltage of the scan pulse applied to scan electrode SCi in the address period. This setting allows address operation to be caused stably without using forced initializing operation. The reason for this is considered as shown below.

First, (Condition 1) is described. In order to cause address discharge, discharge is required to be started between data electrode Dj and scan electrode SCi. In order to start the discharge by applying relatively low voltage Vda to data electrode Dj, sufficient positive wall voltage must be accumulated on data electrode Dj so as to apply voltage substantially equal to discharge start voltage VFds between data electrode Dj and scan electrode SCi when a scan pulse is applied to scan electrode SCi. Since no forced initializing operation is performed and discharge is not caused in the discharge cell for displaying black in the present embodiment, the wall voltage cannot be controlled actively and the wall voltage of the discharge cell for displaying black becomes unstable. When a few charged particles exist in the discharge space even in this discharge cell, however, the charged particles move to each electrode so as to reduce the electric field in the discharge space, and adhere to the wall of the discharge cell to accumulate wall voltage.

First, the accumulated wall voltage is described. In the sustain period, many charged particles occur in the discharge cell for causing sustain discharge. Therefore, it is considered that the charged particles diffuse and a slight part of them is supplied also to the space in the discharge cell for displaying black without causing sustain discharge. Therefore, in the discharge cell for displaying black, wall voltage is gradually accumulated so as to reduce the electric potential difference between electrodes by voltage applied to each of scan electrode SCi, sustain electrode SUi, and data electrode Dj. When the voltage which the wall voltage approaches (finally becomes stable) is defined as left wall voltage, the left wall voltage when a sustain pulse is continuously and alternately applied to scan electrode SCi and sustain electrode SUi is the voltage between the high-side voltage and the low-side voltage of the sustain pulse. A driving voltage waveform other than the sustain pulse is actually applied, so that it may be considered that the left wall voltage of each discharge cell is substantially close to the low-side voltage of the sustain pulse.

The left wall voltage is largely affected by the charge characteristic of the phosphor applied to the inside of the discharge cell. In the present embodiment, the charge characteristic of a red phosphor is +20 (μC/g), the charge characteristic of a green phosphor is −30 (μC/g), and the charge characteristic of a blue phosphor is +10 (μC/g). Only the green phosphor has a characteristic of charging to negative electric potential, so that the left wall voltage for the green phosphor is lower than those for the red and blue phosphors.

Next, the voltage in the discharge cell in the address period is described. On data electrode Dh of the discharge cell for displaying black, wall voltage is gradually accumulated to substantially reach the low-side voltage of the sustain pulse or the left wall voltage higher than it. Voltage Va of the scan pulse of the present embodiment is the voltage satisfying (Condition 1). Therefore, on data electrode Dh, positive wall voltage enough to cause the address discharge is accumulated, and address discharge can be caused even when forced initializing operation is not performed at all.

The wall voltage of the discharge cell for displaying black gradually approaches the left wall voltage. In the erasing period, when the voltage derived by adding the wall voltage to the voltage between “data electrode and scan electrode” approaches the discharge start voltage, dark current flows to reduce the wall voltage on data electrode Dh. The dark current flowing at this time plays a role as priming assisting address discharge, so that stable address discharge can be caused without causing long discharge delay even in the discharge cell having displayed black.

Thus, the driving voltage to be applied to each electrode is set to be low so as to satisfy (Condition 1), especially voltage Va of the scan pulse is set to be low so as to satisfy (Condition 1), thereby accumulating the wall voltage required for address without forced initializing operation and also causing the priming for stabilizing the address discharge.

Next, (Condition 2) is described. When the voltage Va of the scan pulse is excessively decreased, discharge occurs to make image display impossible regardless of the existence of the address operation at the time when voltage Vs of the sustain pulse is applied to the scan electrode in the sustain period. In order to suppress this improper discharge, the voltage between “data electrode and scan electrode” must be set to be discharge start voltage VFsd or lower at the time when voltage Vs of the sustain pulse is applied. This condition is (Condition 2).

Thus, the driving voltage waveform is set so as to satisfy (Condition 1) and (Condition 2) in all discharge cells in the present embodiment. Therefore, the forced initializing operation can be omitted while the address operation is stably caused, and image display where light emission related to no gradation display is eliminated is allowed.

In the present embodiment, the following processes are performed in the erasing period:
causing first discharge where sustain electrode SUi is used as the negative electrode and scan electrode SCi is used as the positive electrode;
then, causing first discharge where scan electrode SCi is used as the negative electrode and data electrode Dk is used as the positive electrode;
then, causing second discharge where sustain electrode SUi is used as the negative electrode and scan electrode SCi is used as the positive electrode; and
then, causing second discharge where scan electrode SCi is used as the negative electrode and data electrode Dk is used as the positive electrode. In order to reduce these discharges and suppress light emission caused by the discharges, the following processes are performed:
applying fourth voltage 0 (V) to sustain electrode SUi and applying an up-ramp waveform voltage whose gradient is 10 (V/μs) to scan electrode SCi;
then, applying a down-ramp waveform voltage whose gradient is −1.5 (V/μs) to scan electrode SCi;
then, applying a positive rectangular voltage whose rising time is equal to or less than 1 (μS) to scan electrode SCi; and
then, applying fifth voltage Ve, which is higher than fourth voltage 0 (V), to sustain electrode SUi and applying a down-ramp waveform voltage whose gradient is −1.5 (V/μs) to scan electrode SCi.

Thus, even when strong discharge is not caused, by repeatedly causing feeble discharge a plurality of times, sufficient wall voltage can be accumulated on each electrode and subsequent address discharge can be stably caused.

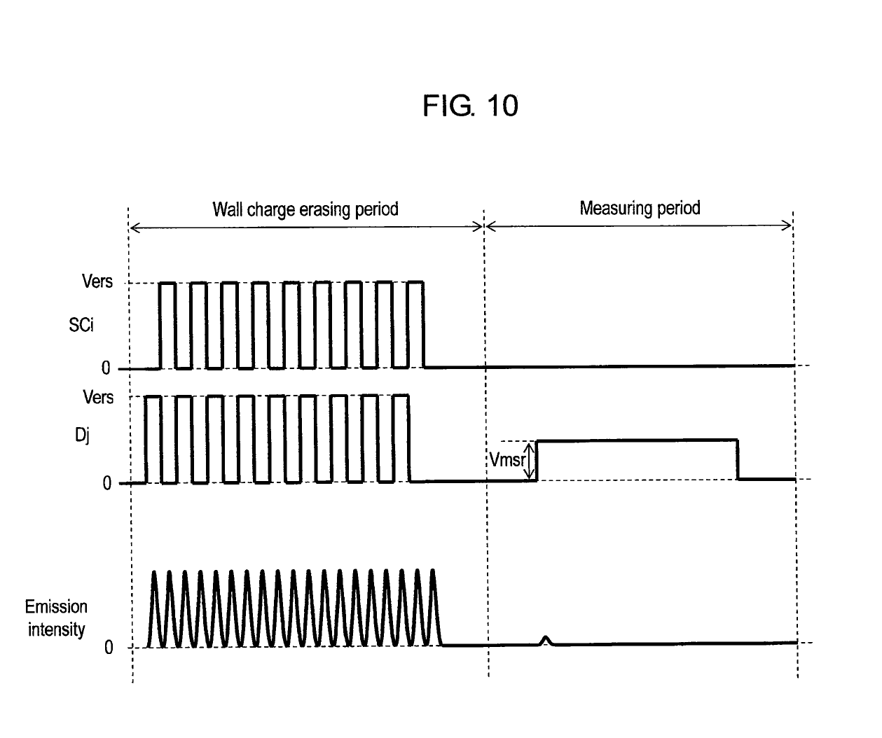

Next, discharge start voltage VFsd, discharge start voltage VFds, and wall voltage can be measured by a method described in IEEE TRANSACTIONS ON ELECTRON DEVICES, VOL. ED-24, NO.7, JULY, 1977 “Measurement of a Plasma in the AC Plasma Display Panel Using RF Capacitance and Microwave Techniques”. Alternatively, they may be simply measured as shown below. One example of the method of simply measuring the discharge start voltages is described using FIG. 10.

First, operation of erasing wall charge is performed. Specifically, as shown in the wall charge erasing period of FIG. 10, pulse-like voltage Vers sufficiently higher than an estimated discharge start voltage is alternately applied to electrodes intended to be measured, for example the data electrode and scan electrode. Then, the start of discharge is observed. Specifically, as shown in the measuring period of FIG. 10, pulse-like voltage Vmsr lower than the estimated discharge start voltage is applied to one of the electrodes, for example the data electrode, and light emission following the discharge at this time is detected using a light detection sensor such as a photomultiplier tube. When discharge is not observed, the operation of erasing wall charge is performed in the wall charge erasing period, then pulse-like voltage Vmsr whose absolute value is slightly increased is applied in the measuring period, and light emission is observed.

This operation is repeated, and voltage Vmsr that has the minimum absolute value and at which light emission is observed in the measuring period is discharge start voltage. When voltage Vmsr applied in the measuring period is assumed to be positive, discharge start voltage VFds where the data electrode is used as the positive electrode and the scan electrode is used as the negative electrode can be measured. When voltage Vmsr applied in the measuring period is assumed to be negative, discharge start voltage VFsd where the data electrode is used as the negative electrode and the scan electrode is used as the positive electrode can be measured.

After the discharge start voltage is measured, by measuring the voltage at which discharge starts in the discharge cell having accumulated wall voltage, wall voltage can be obtained by calculating the difference between the voltage value and the previously measured discharge start voltage.

In the driving method for the panel and the plasma display apparatus of the present embodiment, by applying the scan pulse satisfying the above-mentioned conditions to scan electrodes, stable address operation can be performed and the contrast is improved without using the forced initializing operation.

The specific numerical values shown in the present exemplary embodiment are simply an example. Preferably, these numerical values are set optimally in response to the characteristic of the panel and the specification of the plasma display apparatus.

The specific numerical values shown in the first exemplary embodiment and the second exemplary embodiment are simply an example. Preferably, these numerical values are set optimally in response to the characteristic of the panel and the specification of the plasma display apparatus.

### INDUSTRIAL APPLICABILITY

The present invention provides a driving method for a plasma display panel and a plasma display apparatus where stable address discharge can be caused while sufficient voltage setting margin is secured and an image of high display quality can be displayed. Forced initializing operation is omitted while address operation is performed stably, light emission that is not related to gradation display is eliminated, and the contrast is largely improved. Therefore, the present invention is useful for a driving method for a plasma display panel and a plasma display apparatus.

### REFERENCE MARKS IN THE DRAWINGS

10 panel
22 scan electrode
23 sustain electrode
24 display electrode pair
32 data electrode
35 phosphor layer
40 plasma display apparatus
41 image signal processing circuit
42 data electrode driver circuit
43 scan electrode driver circuit
44 sustain electrode driver circuit
45 timing generation circuit
50, 80 sustain pulse generation circuit
51, 81 power recovery circuit
60 ramp waveform voltage generation circuit
61, 62, 63 Miller integrating circuit
70 scan pulse generation circuit
85 fixed voltage generation circuit

1. A driving method for a plasma display panel comprising:
forming one field using a plurality of subfields each of which has an initializing period, an address period, and a sustain period; and
driving the plasma display panel having a plurality of discharge cells each of which has a scan electrode, a sustain electrode, and a data electrode,
wherein, in the initializing period in at least one of the plurality of subfields, selective initializing operation of selectively causing initializing discharge is performed only in a discharge cell that has undergone address discharge in an immediately preceding address period, and
wherein the selective initializing operation includes:
applying first voltage to the sustain electrode and applying an up-ramp waveform voltage to the scan electrode;
applying a first down-ramp waveform voltage to the scan electrode and then applying a positive rectangular voltage to the scan electrode; and
applying second voltage higher than the first voltage to the sustain electrode and applying a second down-ramp waveform voltage to the scan electrode.

2. A plasma display apparatus comprising:
a plasma display panel having a plurality of discharge cells each of which has a scan electrode, a sustain electrode, and a data electrode; and
a driver circuit that forms one field using a plurality of subfields each of which has an initializing period, an address period, and a sustain period, generates a driving voltage, and applies the driving voltage to each electrode of the plasma display panel,
wherein the driver circuit, in the initializing period in at least one of the plurality of subfields, drives the plasma display panel by applying first voltage to the sustain electrode and applying an up-ramp waveform voltage to the scan electrode, then applying a first down-ramp waveform voltage to the scan electrode, then applying a positive rectangular voltage to the scan electrode, and then applying second voltage higher than the first voltage to the sustain electrode and applying a second down-ramp waveform voltage to the scan electrode.

3. A driving method for a plasma display panel comprising:
forming one field using a plurality of subfields each of which has an address period, a sustain period, and an erasing period; and
driving the plasma display panel having a plurality of discharge cells each of which has a scan electrode, a sustain electrode, and a data electrode,
wherein, when
first voltage is assumed to be voltage derived by subtracting voltage applied to the data electrode from low-side voltage of a sustain pulse applied to the scan electrode in the sustain period,
second voltage is assumed to be voltage derived by subtracting voltage applied to the data electrode from high-side voltage of the sustain pulse applied to the scan electrode in the sustain period, and
third voltage is assumed to be voltage derived by subtracting low-side voltage of an address pulse applied to the data electrode from low-side voltage of a scan pulse applied to the scan electrode in the address period,
voltage derived by subtracting the third voltage from the first voltage is not lower than a discharge start voltage where the data electrode is used as a positive electrode and the scan electrode is used as a negative electrode, and
voltage derived by subtracting the third voltage from the second voltage is lower than the sum of a discharge start voltage where the data electrode is used as a positive electrode and the scan electrode is used as a negative electrode and a discharge start voltage where the data electrode is used as a negative electrode and the scan electrode is used as a positive electrode,
wherein, in the erasing period, erasing discharge is selectively caused only in a discharge cell that has undergone address discharge in an immediately preceding address period, and
wherein the erasing discharge includes:
causing first discharge where the sustain electrode is used as a negative electrode and the scan electrode is used as a positive electrode;
causing first discharge where the scan electrode is used as a negative electrode and the data electrode is used as a positive electrode;
causing second discharge where the sustain electrode is used as a negative electrode and the scan electrode is used as a positive electrode; and
causing second discharge where the scan electrode is used as a negative electrode and the data electrode is used as a positive electrode.

4. The driving method for the plasma display panel of claim 3, wherein the erasing discharge includes:
causing first discharge where the sustain electrode is used as a negative electrode and the scan electrode is used as a positive electrode by applying fourth voltage to the sustain electrode and applying an up-ramp waveform voltage to the scan electrode; and
causing second discharge where the sustain electrode is used as a negative electrode and the scan electrode is used as a positive electrode by applying fifth voltage higher than the fourth voltage to the sustain electrode and applying a down-ramp waveform voltage to the scan electrode.

5. A plasma display apparatus comprising:
a plasma display panel having a plurality of discharge cells each of which has a scan electrode, a sustain electrode, and a data electrode; and
a driver circuit that forms one field using a plurality of subfields each of which has an address period, a sustain period, and an erasing period, generates a driving voltage waveform, and applies the driving voltage waveform to each electrode of the plasma display panel,
wherein the driver circuit drives the plasma display panel in the following manner:
first voltage is assumed to be voltage derived by subtracting voltage applied to the data electrode from low-side voltage of a sustain pulse applied to the scan electrode in the sustain period;
second voltage is assumed to be voltage derived by subtracting voltage applied to the data electrode from high-side voltage of the sustain pulse applied to the scan electrode in the sustain period;
third voltage is assumed to be voltage derived by subtracting low-side voltage of an address pulse applied to the data electrode from low-side voltage of a scan pulse applied to the scan electrode in the address period;
voltage derived by subtracting the third voltage from the first voltage is not lower than a discharge start voltage where the data electrode is used as a positive electrode and the scan electrode is used as a negative electrode; and
voltage derived by subtracting the third voltage from the second voltage does not exceed the sum of a discharge start voltage where the data electrode is used as a positive electrode and the scan electrode is used as a negative electrode and a discharge start voltage where the data electrode is used as a negative electrode and the scan electrode is used as a positive electrode, and
in the erasing period, the following processes are performed:
causing first discharge where the sustain electrode is used as a negative electrode and the scan electrode is used as a positive electrode;
then, causing first discharge where the scan electrode is used as a negative electrode and the data electrode is used as a positive electrode;
then, causing second discharge where the sustain electrode is used as a negative electrode and the scan electrode is used as a positive electrode;
then, causing second discharge where the scan electrode is used as a negative electrode and the data electrode is used as a positive electrode; and
selectively causing erasing discharge only in a discharge cell that has undergone address discharge in an immediately preceding address period.
